(19) United States
(12) Patent Application Publication
(10) Pub. No.: US 2023/0045235 A1
(43) Pub. Date: Feb. 9, 2023

(54) TRUSTED APPLICATION RELEASE ARCHITECTURE AND DASHBOARD

(71) Applicant: VMware, Inc., Palo Alto, CA (US)

(72) Inventors: Kris K. Pierscieniak, Palo Alto, CA (US); Shanqiang Huang, Palo Alto, CA (US); Raya! Preet Bagga, Palo Alto, CA (US)

(21) Appl. No.: 17/383,693

(22) Filed: Jul. 23, 2021

(51) Int. Cl. G06F 21/57; G06F 8/71; G06F 8/65

(52) U.S. Cl. CPC G06F 21/57; G06F 8/71; G06F 8/65

(57) ABSTRACT

A system can include a software release management platform for centrally managing software lifecycles and product releases. The platform can allow for creation of a policy file that defines a release workflow with multiple release stages. The platform can run a release pipeline based on the policy file, triggering release stages based on file tagging and metadata. The platform can also automate containerized tools that perform the stages of the release workflow. The progress of the release workflow can be displayed in a graphical user interface (“GUI”). The GUI can display multiple release workflows with release stages for each. When the user clicks on a release workflow or release stage multiple individual steps and the status of the individual steps can be displayed.

### BACKGROUND

Development of software solutions that span large or multiple organizations require real-time orchestration between many separate teams. These teams can leverage different tools and processes to build, test, audit, and release software. The process is slow, prone to human errors, and reliant on a heterogeneous collection of tools that are not well integrated together. Current release processes are highly reliant on expertise in key roles to bring software solutions to market. The current processes are not highly integrated, and instead rely on various individuals to run multiple different tools. Often there is no record of what exactly was done by these individuals in a particular release, such as which bits were used, who edited what, and other details. This leads to lower reliability and visibility in the release process.

As organizations scale, it becomes increasingly important for release processes to be predictable and auditable. A large organization may have hundreds of different software products, all of which go through many iterations of releases. Setting up these releases can involve a lot of release-specific programming and auditing the releases can likewise be time consuming and difficult. The releases can cumulatively involve thousands of developers and customers all over the world. Even enforcing standards of which tools and steps to use in the releases can become unwieldy. Therefore, organizations generally need to attain higher scalability, improved auditability, and end-to-end predictability for their Software Lifecycle Development (“SLDC”) and product releases.

Current systems are generally unreliable, ungoverned by any central eco-system of integrated tools, and require many manual verifications from users that are not centrally tracked. There is no single place to track releases statuses, issues, and communications.

Therefore, a need exists for a trusted application release architecture and dashboard for the same.

### SUMMARY

Example implementations of technology described herein include systems and methods for managing software releases using policy files and a release platform that creates and manages release pipelines based on the policy files. Unlike prior methods, the method can provide a scalable and secure policy management service in a centrally managed location. The release platform can allow users to define, verify, enforce, and audit security policies for release tools and services in compliance with defined controls. The release platform can also provide common language for defining policies based on standards. The release platform can also enable users to collect all the audit events at the central location and generate reports or output data for use by other systems.

An integration engine can execute stages of the release policy with multiple different tools. The tools for each stage of a release cycle can be specified by a policy file. The tools can run in their own containers, allowing for isolation of individual tools and scaling of the system to work with any number of tools. The integration engine can interface with any number of tools or other components of the release and automate use of some or all of those tools. A graphical user interface (“GUI”) (also called a dashboard) of the release platform can visualize policy creation and display release pipeline progress based on one or more policies.

In one example, the system can allow a user to create a policy file. The policy file can define a release workflow with multiple release stages. In one example, these release stages can include polling sources, virus scanning, and creating download groups. The polling sources stage can specify where to look for bits and files that will be used to assemble the application release. The virus scanning stage can scan the bits and files for viruses using various tools. The creation of download groups stage can involve placing the application release at a target location and providing links to the application with appropriate graphics or descriptions.

In one example, the release pipeline is triggered based on a status of the policy file, such as when the status is changed to “publish.” Multiple release pipelines can execute in parallel based on multiple different policy files. The system can poll a location for policy files to recognize newly published files in an example. Once the system is running a release pipeline, the system can also check for metadata at files and locations specified by the policy file for purposes of triggering pipeline stages and individual steps for those stages.

Additionally, stages of the release pipeline and individual steps of those stages can be triggered by release metadata. One type of metadata can be file tags. For example, users can tag files when they are ready to be used as part of a release. The release pipeline can wait to ensure that all the needed files and bits are tagged appropriately before using them in the relevant release stage. Additionally, the platform can collect metadata of the results of release stages and individual steps of those release stages. These results can dictate whether a subsequent stage of the release pipeline is triggered. The results can also trigger other action by the platform, such as notifying users that their review or input is needed on a particular stage or individual step.

A release stage can include multiple steps and utilize multiple different tools to perform these steps. The tools can be containerized to operate with the integration engine. This can help isolate the tool processes and provide an application programming interface (“API”) that allows the integration engine to run the tools according to the policy file.

The platform can also include a dashboard for viewing release progress and auditing a release. The dashboard can be presented in a GUI. In one example, the GUI can present multiple different release pipelines that the user has access to. The GUI can simultaneously display the release pipelines in rows, identifying the product, release, and milestone. In one example, each pipeline can also be displayed with stage status for multiple stages of that pipeline. For example, the GUI can display three of the release stages with a respective status for each of the displayed release stages. When a user selects a pipeline or one of the release stages of the pipeline, the GUI can display the multiple individual steps for the release stage and the status of the individual steps. The individual steps can be, for example, source files processed, virus scans performed, or contents populated for a download group.

The examples summarized above can each be incorporated into a non-transitory, computer-readable medium having instructions that, when executed by a processor associated with a computing device, cause the processor to perform the stages described. Additionally, the example methods summarized above can each be implemented in a system including, for example, a memory storage and a computing device having a processor that executes instructions to carry out the stages described.

Both the foregoing general description and the following detailed description are exemplary and explanatory only and are not restrictive of the examples, as claimed.

### BRIEF DESCRIPTION OF THE DRAWINGS

FIG. 1 is a flowchart of an example method for policy-based software release management.

FIG. 2 is a system diagram of an example components for policy-based software release management.

FIG. 3 is a flowchart of an example method for performing actions for policy-based software release management.

FIG. 4 is a flowchart of an example method for performing actions for policy-based software release management.

FIG. 5 is an illustration of an example GUI screen for policy-based software release management.

FIG. 6 is an illustration of an example GUI screen for policy-based software release management.

FIG. 7 is an illustration of an example GUI screen for policy-based software release management.

FIG. 8 is an illustration of an example GUI screen for policy-based software release management.

### DESCRIPTION OF THE EXAMPLES

Reference will now be made in detail to the present examples, including examples illustrated in the accompanying drawings. Wherever possible, the same reference numbers will be used throughout the drawings to refer to the same or like parts.

A system for managing software release cycles can provide a GUI for creating or opening policy files. A policy file can define a release workflow with multiple release stages. When the policy file is tagged for publication, an integration engine can begin a release pipeline according to the stages of the policy file and related metadata. The release stages can individually be triggered based on metadata and file tagging. A release stage can include the operation of multiple different tools that each operate in containers. The containers can allow for automation by the integration engine.

The system can include a GUI that provides various users with a centralized access point for reviewing the release and for providing input that can be stored as metadata. The GUI can display multiple release pipelines accessible by a user, with status summaries of each release pipeline. For example, for a first release pipeline the GUI can display three of the release stages with a respective status for each of the displayed release stages. The user can then drill down into more details, such as by clicking one of the releases. This can cause the GUI to display the release stages and multiple individual steps for at least one of the release stages. The individual steps can show as completed, failed, or awaiting execution. The user can also review criteria required for executing an individual step or release stage, in an example.

The system can provide a centralized management point for previously unwieldy SDLC that involves many different tools and users. Providing the involved users with a comprehensive view of the release can result in improved system uptime and stability and fewer information technology (“IT”) requests. Based on the policy file, the system can automate many release stages according to tags placed on the relevant files, resulting in simple and predictable deployment of all product components. SDLC status at all stages can be made visible through the GUI, allowing for improved deployment health monitoring and remediation.

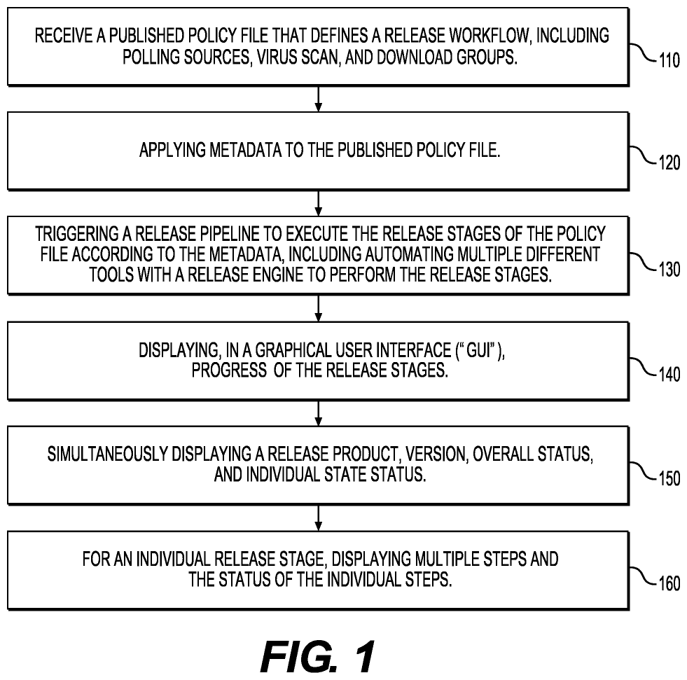

FIG. 1 is a flowchart of an example method for policy-based software release management. The stages can be performed by one or more processes that execute on a server. For example, a dashboard GUI can be generated, and an integration engine can execute release pipelines created by the system based on policy files.

At stage 110, the integration engine can receive a policy file that defines a release workflow. The policy file can be a high-level set of rules (or statements) that governs the behavior of tools and release pipeline services. Policies can encode knowledge on how tools and services need to comply with SDLC requirements. These rules can be defined and managed centrally by various teams involved in the release process, like a security team, release team, or individual service owners. Policy management can include creating and maintaining these policies at a central location with the release platform, including role-based access controls for which users can add and apply policies.

The policy file can establish rules for a product release. For example, it can establish release stages and prerequisites for each stage. It can also establish which tools to run at each stage and where to find metadata needed for running those tools. In general, the policy file can establish which source files and binaries to use, what types of virus scans to run, how long to run virus scans, the staging environment to use for the release, and the target location for the release. The integration engine can enforce these rules and keep a record of which stages and individual steps of stages completed successfully, failed, or require further input. The integration engine can also automate execution of stages, rule following, and record collection.

The policy file can be created by a user through use of the GUI, in an example. For example, the GUI can allow the user to specify release stages. Then the release stages can include individual steps, such as sources to poll and tools to use on particular bits and files. The user can supply this information by creating metadata in the GUI or otherwise entering the information as input to the GUI, in an example.

In one example, users can tag the policy file, such as with a “publish” tag that indicates the policy file is ready for purposes of executing a release pipeline. The specific users that can change the status of the policy file in this way can be managed by the system. For example, a project manager in a developer group and a project manager in the documentation group can each apply the “publish” tag for their respective groups. The policy file can specify that both tags are needed prior to the policy file being considered published. In one example, the integration engine triggers the release pipeline based on a policy file moving from a draft status to a published status based on the appropriate tags.

In one example, the policy file can be selected for publication on the GUI. Such selection can notify the integration engine that the policy file is ready for use. In another example, the integration engine polls one or more file locations to retrieve newly published policy files. This can cause a release pipeline to automatically begin once the policy file is published.

The policy file can be stored in a database in an example. Additionally, each product can have a corresponding policy file that defines how releases occur for that product. In one example, the policy file can include a product, a release version, and a milestone. The milestone can indicate a type of release, such as alpha, beta, or general availability. The policy file can be given a unique identifier (“ID”) that corresponds to the combination of product, release version, and milestone. The policy file can also be assigned versions to designate edits to the policy file for the product, release, and milestone. In one example, authorized users can modify the policy file through the GUI. This can allow users from multiple departments to add rules that correspond to that user's role in the product release.

In one example, the policy file can remain in a draft stage until it has been finalized. At that point, it can enter the published stage. Once it is published, the policy file can be picked up by the integration engine and the pipeline can trigger. The integration engine can periodically scan the database for a newly published policy file or can be alerted by the database when a policy file publishes.

At stage 120, the integration engine can apply metadata to the policy file to determine what pipeline stages to trigger. For example, metadata from the database can designate files as ready to publish or can include tags from users that are used to make decisions according to the policy file. For example, the metadata can establish the number of reviewers of a file, which may need to reach a threshold before the integration engine triggers a stage of the release pipeline. The metadata can also include tokens and credentials needed for accessing various databases or tools used in the release pipeline.

When the metadata changes after a release pipeline has already begun, the database or some other service can notify the integration engine. The integration engine can then attempt to retrieve new or changed metadata for use in executing the release pipeline.

In general, because the system can trigger stages automatically, the system can maintain simplicity for product deployment and reduce manual interactions that can lead to unexpected delays and results. This can reduce lead-time for staging to deployment through better subsystem integration.

At stage 130, the integration engine can trigger execution of a release stage specified in the pipeline. The triggering can occur when a combination of rules is met. For example, the integration engine may need a trigger for when a new policy file is created, for when the policy file is updated, and when a policy file has expired. In addition, any of the rules in the policy file in combination with metadata can act as a trigger prerequisite for a particular stage or step within a stage.

A particular step of a stage can include executing a tool on a source file. The tool can be containerized with an exposed API for purposes of automation by the integration engine. This can allow tools to run in their own containers while being controlled by the integration engine. The containers can include functions that can be called with commands from the integration engine. Any existing tool used in software releases is a candidate for automation by the integration engine.

Release stages can be specified in a policy file. As an example, these stages can include polling sources, virus scanning, and creating download groups, among other release stages. A polling sources stage can ensure that the correct binaries and files are in the specified locations and meet the criteria for a release. The criteria can include a minimum number of reviewers, authorization by a user having a specific job category or status, and a file status indicating that the file or binary is ready for publication. A virus scanning stage can specify which files or file types to scan for viruses, which tools to use for the scanning, and how long the scanning can last. A download groups stage can specify how the release is presented on a webpage or app store, such as which graphics and text to use, where to present this information relative to other available products, and various links for documentation and other product-related features. The download group stage can be part of same pipeline as application code or can be run separately in a different pipeline. Any release stages are possible, and the stages are not limited to polling, virus scanning, and download groups. However, these three stages are used herein for illustrative purposes.

The policy file can list the various stages that will be included in the pipeline. The policy file can also list prerequisites for a release stage. For example, the virus scan stage can execute after prerequisite completion of the polling stage. The download groups stage can execute after the completion of the virus scan stage. The policy file can specify metadata sources for use in executing the stages.

At stage 140, a GUI can display progress of the release stages. Users across an organization can log into the dashboard and use the GUI to see the status of a product release. The users who can see a particular release pipeline can depend on which users have rights to access the pipeline. For example, a policy file can be created with rights to specific organizational groups and users. If the user is a member of one of those organizational groups or specifically granted access to the policy file, the user can see the resulting release pipeline in the GUI in an example. The user can be presented with multiple release pipelines that can be complete or pending. This can allow the user to see the status of several different release pipelines that may be related or unrelated to one another.

The GUI can display on a user device, which can be any processor-enabled device. Examples include a phone, laptop, tablet, or workstation. The GUI can be accessible from a web server in an example, allowing the user to monitor the status of a product release from any location.

In one example, at stage 140 the GUI can simultaneously display multiple release pipelines with information regarding product, version, overall status, and individual stage status for the various displayed releases. The GUI can display three or more release stages for each of the release pipelines on the screen, in an example. This can allow the user to quickly see the state of various release pipelines, which may be related. For example, a software product release pipeline can be displayed simultaneously with a documentation and downloads release pipeline. When the production or beta software is uploaded to a target location, the software pipeline can end. That can be a prerequisite for stages of the documentation pipeline to complete such that links are published for receiving documentation regarding the software.

When the user selects a particular release pipeline, at stage 160 the GUI can display individual steps for one or more release stages of the release pipeline. For example, if the user selects the polling stage, the individual files being retrieved can be displayed on the GUI, with results for each attempt. Similarly, selecting the virus scan stage can display which files and binaries have been scanned by which tools, and the result.

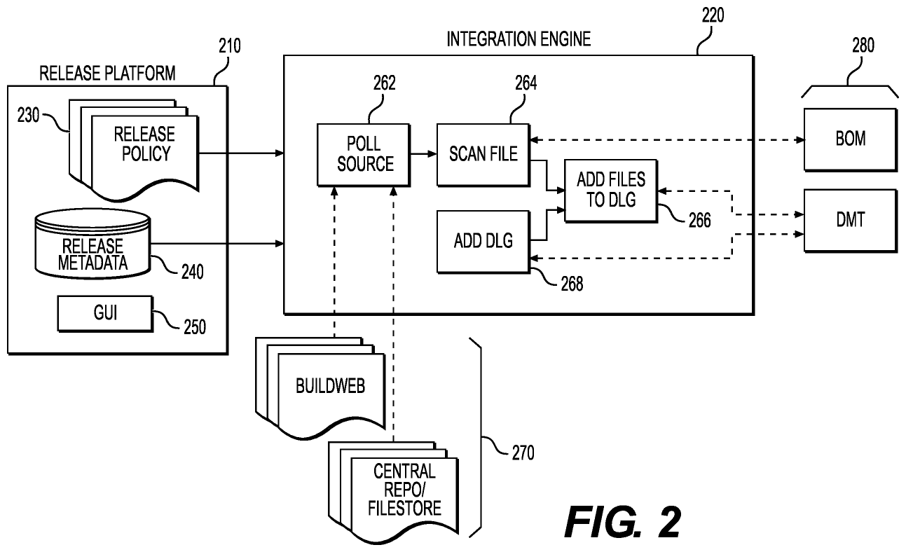

FIG. 2 is a system diagram of example components for policy-based software release management. A release platform 210 can execute on a server. The server can be comprised of one or multiple processor-enabled devices, including multiple servers in an example. The release platform 210 can allow users to visualize release pipeline progress on a GUI 250 and create policy files representing release policies 230. Metadata 240 can also be stored in a database and viewed in the GUI 250, in an example. Some metadata 240 can be user-defined for use with the release policy 230, whereas other metadata is generated by the release pipeline.

The integration engine 220 can execute on the same or different server(s) as the release platform 210. The integration engine 220 can execute a release pipeline according to the policy file. The pipeline can include multiple release stages, in an example.

In one example, system workflow begins with one or more users defining a release policy 230, which can be a policy file. The policy file can be in a JSON format in one example. The users can also define some of the release metadata 240. The policy file and metadata 240 can be stored in the database, in an example.

A portion of an example policy file is shown below:

| | |
|---|---|
| “stages”: | [ |
| | { |
| | “name”: “poll”, |
| | “prerequisite”: null |
| | }, |
| | { |
| | “name”: “virus-scan”, |
| | “prerequisite”: “poll” |
| | }, |
| | { |
| | “name”: “download-group”, |
| | “prerequisite”: “virus-scan” |
| | } |
| | ], |

This portion can define release stages for the pipeline along with prerequisites for beginning a particular stage. For example, the virus-scan stage cannot begin until the poll stage has completed. Likewise, download-group can begin after virus-scan is completed.

The policy file can further specify sources that are required for each stage. The sources can be files or tools. The sources can require particular tags from specified users or users having specified credentials. The tools and files can be identified according to servers, paths, and file names.

The integration engine 220 can read the policy file and trigger a release pipeline to execute the various release stages defined in the policy file. For example, the release platform can expose APIs to allow the integration engine 220 to recognize a change to policy files and trigger pipelines. In one example, the integration engine 220 can get a list of all published policy files not yet downloaded by the integration engine 220, each policy including a policy identifier and version number. The integration engine 220 can scan the JSON contents of a new or changed policy file and create a release pipeline based on those contents. In this example, the release stages can include polling a source 262, scanning a file 264, and download groups. The download groups stage is shown broken into two individual steps 266, 268. Additionally, a single policy file can have release stages that execute in parallel in parallel release pipelines in an example.

The poll sources stage 262 can include polling on sources that will be part of the release. The policy file can specify locations and tools 270 to use, such as BuildWeb and a central repository or file store. BuildWeb is an example tool that helps execute websites and build scripts. But any tool can be specified by the policy file. Different tools are useful for different tasks, depending on what type of product is being released.

After the poll sources stage 262 is complete, the policy file can specify that the integration engine 220 begin the scan file stage 264, which can be a virus scanning stage. The policy file can specify one or more tools 280 to use in this stage 264, such as a bill of materials (“BOM”) tool. For example, the BOM tool can compile a list of licenses, open-source components, and third-party components that are part of the product being released. However, other tools can also be specified.

The download groups stages 266, 268 can use a data moving tool (“DMT”) specified in the policy file. The DMT can extract, transform, and load data to a source. Metadata can specify descriptive content that the DMT loads into various forms or fields to create download links and information for the release. The download groups stage can begin with a first step 268 of adding a download group. Then, at a second step 266 of the download groups stage, the integration engine can use the DMT to add files to the download groups.

When the release pipeline is complete, the integration engine 220 can mark the policy file as processed or destroyed. Results of the run can be stored in the database for review on the GUI 250. The policy file can remain available for use in case the release pipeline needs to be run again. Old policy files can be marked as expired according to an expiration date for each policy file in the database.

In one example, the policy file (e.g., release policy 230) can be created or edited in the GUI 250 and stored with metadata 240 in the database. Many different rules can be specified using the GUI 250, in an example. Example policy rules can include a number of approvers or reviewers needed, the requirement for a repository to have a named owner, reviewers per merge of a file into a larger project, and API tokens required for tool or repository access, among others.

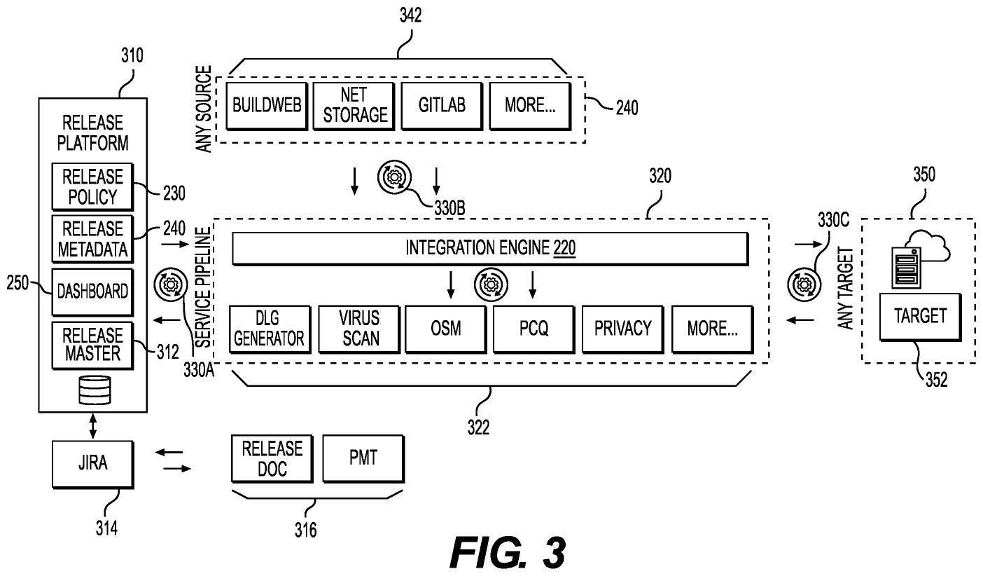

FIG. 3 is a flowchart of an example method for performing actions for policy-based software release management. A release platform 310 can execute a dashboard GUI 250, allowing users to create and modify a release policy 230, resulting in a policy file. Users can also create release metadata 240. The policy file and release metadata 240 can be stored in a database. The release policy 230 can define the overall SDLC workflow, such as the source 342 of the software bits, the files to publish, the tools 322 and services to run the bits and files on, and the target 350, 352 where generated sources will be placed.

The release platform 310 can extend a release master 312. The release master 312 can act a single source of truth of release information. The release information can include the product, version, a release manager, and a project manager. The release platform 310 generally can provide management of the release policy 230 and release metadata 240. The users can make any source 342 and any target 350 part of the release policy 230 using the GUI 250, in an example. This allows the release policy 230 to cause the integration engine 220 to dynamically choose the release sources 342, the release tools 322, and the release target 352. The GUI 250 can also provide a single panel to view the release pipeline status. The integration engine 220 together with any available and relevant tools 322 can collectively be referred to as a [symbol] pipeline 320.

At stage 330A, the integration engine 220 can trigger execution of a pipeline based on an API call between the release platform 310 and the integration engine 220. The pipeline can include release stages that execute using various tools 322 described in the release policy 230. The integration engine 220 can poll sources 342 and collect files and bits to publish at stage 330B. This can include making requests to the relevant storage repositories or applications. The integration engine 220 can provide tokens for credentials as specified in the policy file.

Then the integration engine 220 can apply various tools 322 to the files and bits in the release stages. The example tools 322 in FIG. 3 include a download groups (“DLG”) generator, a virus scan tool, an OpenStreetMap (“OSM”) software catalog tool, a personal computer Q methodology (“PCQ”) tool, a data privacy analysis tool, and more. These tools 322 can each be containerized with exposed APIs for operation with the integration engine 220. This can allow the automation of most tools 322. However, other tools 316 that are not automated by the integration engine 220 can be managed by project tracking software 314, such as JIRA. That software 314 can interface with the release platform 310 in an example, allowing the release platform 310 to update metadata 240 based on status in the project tracking software 314. The updated metadata 240 can trigger further release stages or individual steps of stages by the integration engine 220.

At stage 330C, the integration engine 220 can place the generated sources at a target 352 for access by an end user or customer. The target 352 can be selected based on the policy file and metadata 240, in an example. For example, if the policy file indicates a beta version, the target 352 may be different than if the same product is indicated as a full release version. The target 352 can be located on a server that is accessible by one or more users who are allowed to access the generated sources for the product.

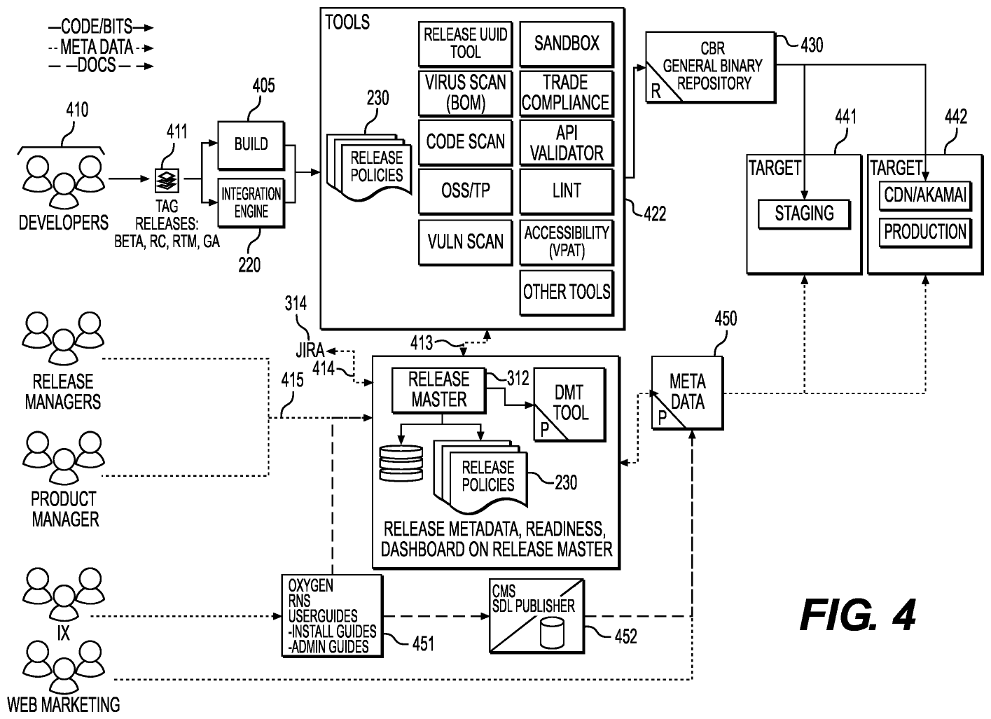

FIG. 4 is a flowchart of an example method for performing actions for policy-based software release management. Various groups of users 410 can tag files needed for a release. For example, at stage 411 developer users 410 can tag release files and a policy file. The policy file can be tagged to publish. Additionally, files can be tagged for beta or production. Developers can have code that they believe is ready to be released and can tag the code according to the status they believe the code should receive. This can include tagging various files and bits appropriately.

The existence of a published policy file can trigger the integration engine to build a release pipeline at stage 405. The integration engine 220 can recognize the tags applied at stage 411 and apply those files to release policies 230 described in the policy file. The policy can apply relative to the tags, with different tools and targets involved depending on the tags applied to the files. For example, when bits have reached the beta milestone, a release pipeline for a beta production can run by applying rules in the release policies 230.

The release policies 230 (of the policy file) can specify tools 422 that the integration engine 220 can execute. These tools 422 can be executed based on the policies 230 at the specified release stages and in accordance with identified metadata. The set of tools 422 is dynamic and can be any tools specified by the users who create the policy file.

Tagging can be uniform across an enterprise in an example. Departments can apply their own tags to files. Tags can trigger different policies for the pipeline. For example, release managers, a product manager, an interaction designer (“IX”) user, and a web marketing team can all apply various tags to files involved in a release. These tagged files can be picked up by the integration engine 220 at different stages of the release.

Additionally, multiple different release policies 230 can be involved based on multiple policy files. In one example, the release managers and product manager users 410 can tag files at stage 415 that are part of a group of release master 312 files separate from those being tagged by the developers. Parallel release pipelines can execute and the different groups of users 410 can see the statuses of the parallel pipelines. For example, documentation such as release notes, installation guides, configuration guides, and security guides can be published on a first release pipeline whereas the actual software for download can be published on a second release pipeline.

Alternatively, the groups of users 410 can all contribute to a single release pipeline. The release master 312 can be viewable by all the groups of users 410 on a dashboard GUI 250. The different groups of users 410 can apply tags to the same files and to non-overlapping files. The users 410 can supply different code, metadata, and documents needed for the release. The release policies 230 can require specific tags from multiple of these groups before proceeding with a particular release stage and running a particular tool 422. For example, the DMT tool can execute on files that have been tagged as ready for production by both developer and release manager users 410. The policy file can cause the GUI 250 to notify a user with what they need to do for the release to proceed. For example, a user in the legal department can be notified to perform various tagging actions. The integration engine 220 can recognize the tags when they are applied, which can satisfy an individual step of the release policy 230. The release pipeline can then proceed to the next step when the first step was a prerequisite.

The dashboard GUI 250 can allow these different groups of users 410 to access the release master 312 and see the status of the release pipeline. Some parts of the release can be manually run as well, with updates being tracked in project management software 314 such as JIRA. At stage 414, the project management software 314 can supply an updated status as metadata that gets used by the integration engine 220 to determine if requirements of the release policy 230 have been met. The metadata can be visualized in the GUI 250, such as by viewing release master 312 database logs.

The metadata from the release database can be supplied to the tools 422 at stage 413. Again, this metadata can be generated by and interacted with by different users 410, such as release managers, product managers, IX users, and marketing users. Various services or microservices 451, 452 and repositories 430 can supply source files that the tools 422 use to generate additional metadata 450.

Eventually, when rules of the release policy 230 at various release stages are met, the files and some portions of the metadata 450 goes to staging 441 or production 442. These different publishing targets can be specified in the policy file.

The entire process can be visualized in the GUI 250. This can provide a centralized source of visibility to all the user groups 410, allowing users to see sources of delay in the release. This can allow for the correct users to see SDLC status at all stages and provide input for remediation where needed. For example, if a step does not happen within a threshold amount of time, another user can be notified and any user can see the progress across the different groups 410.

The integration engine 220 can also log results of the release pipelines. Changes to a policy file can be tracked with different versions of the policy file that are stored in the system database. Multiple pipelines can be executed for a single version of the policy file. These different pipelines can be tracked as multiple runs for that version of the policy file. This can allow for viewing historical metadata of each release pipeline in the GUI 250.

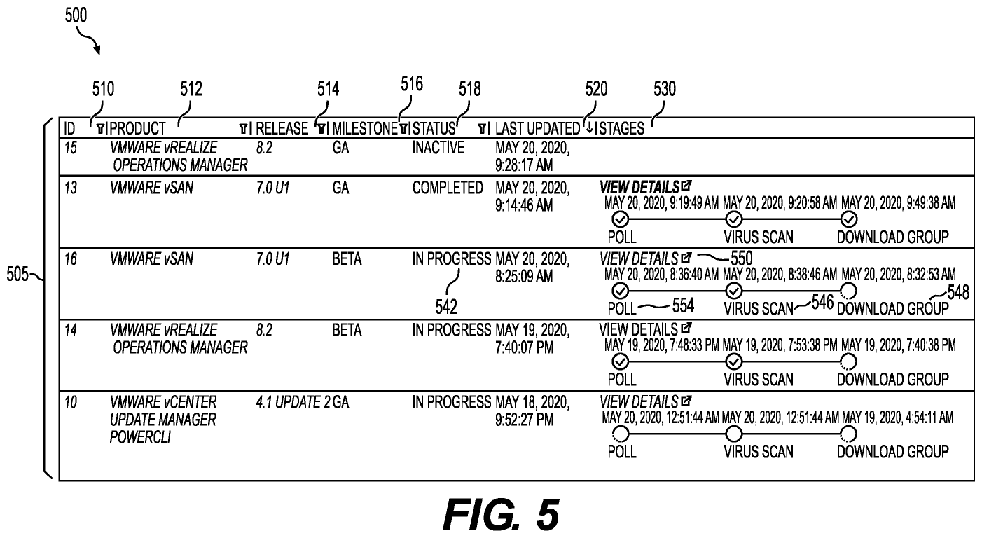

FIG. 5 is an illustration of an example GUI 250 screen 500 for policy-based software release management. The screen 500 can present multiple different release pipelines 505. These pipelines 505 can be generated based on one or more policy files. Each release pipeline 505 can have an ID 510, a product name 512, a release version number 514, a milestone 516, and an overall status 518. The screen 500 can also show the last update 520 to each release pipeline 505.

In one example, the screen 500 also shows multiple stages 530 of the release pipelines 505. The screen 500 can simultaneously display the multiple stages 530 for several pipelines 505, allowing the user to see where related pipelines are in their respective release stages 530. In this example, three release stages 530 are shown for each pipeline 505. The release stages can show as complete or as pending, depending on whether a checkmark is placed by each stage. Additionally, dates and times can display next to each stage so that the user knows when the stage was started or completed.

In the example of FIG. 5, the release stages include poll, virus scan, and download group. The polling stage can involve automatically detecting that a file, code, or document is ready for release. The virus scan can check bits and files for viruses according to the policy rules. The download group stage can involve creating the software for download, such as staging the software and making it available at a target location. The download group stage could be part of same pipeline as application code or could execute in a different pipeline. These release stages are exemplary, and any other release stages can utilize the same workflow described herein.

The dashboard GUI 250 can allow a user to monitor multiple releases. For example, a manager may want to know what is going on across a group or enterprise with releases. An operator user may want to see where the releases are in the cycle. An IT administrator can also see where errors occur for trouble shooting. The GUI 250 screen 500 can allow these different users to have centralized and full visibility of the entire process rather than relying on offline discussions.

The release pipelines 505 displayed can be related or unrelated. For example, pipeline IDs 13 and 16 both relate to VMWARE vSAN releases, with one being BETA and the other being general availability (“GA”). These can have different requirements and different timing characteristics.

The integration engine 220 can use polling to automatically detect that files or code is ready to release based on tags and requirements of a policy file. Metadata can specify file details used by the integration engine 220 for determining which files and code are ready for release. When a release is triggered, the pipeline 505 can display on the screen 500. If a user would like more detail, an individual release pipeline 505 can be selected.

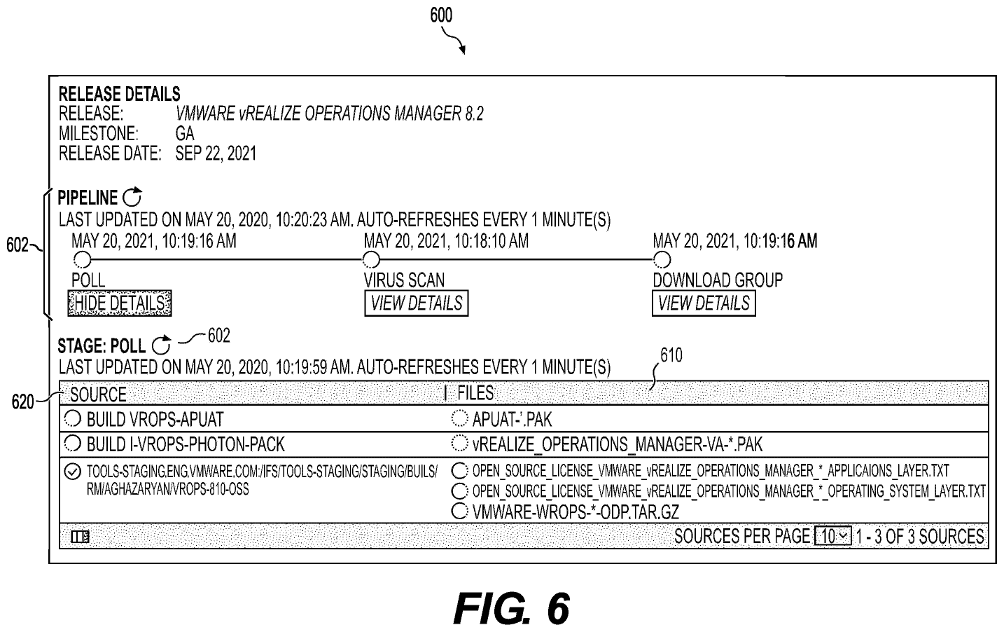

FIG. 6 is an illustration of an example GUI 250 screen 600 for policy-based software release management. The screen 600 can be presented based on the user selecting a pipeline 505 in FIG. 5. The example shown in screen 600 is based on pipeline ID 14, release version 8.2.

Screen 600 can display release details of the selected pipeline 505. For example, a pipeline summary 602 can provide information on the overall release stages, such as whether each stage is complete and the execution timing of the stages. The user can then select to see details of a release stage. In this example, the user has selected to see details of the polling stage.

Release stage details can then provide information regarding individual steps of the release stage. In this example, the individual steps of the polling stage are shown. The individual steps of this stage involve identifying sources 620 and files 610 from metadata stored in the repository.

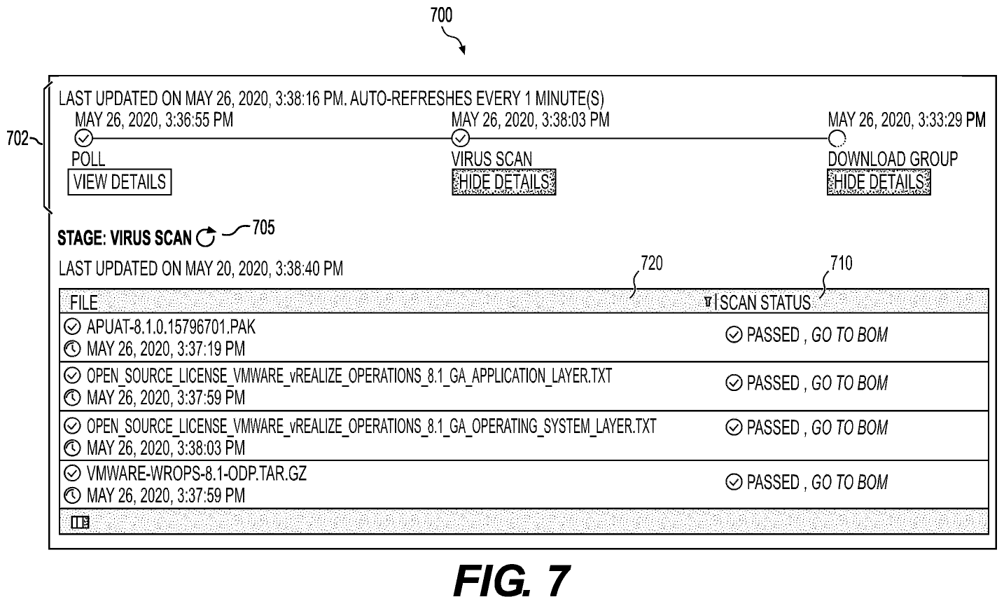

FIG. 7 is an illustration of an example GUI screen 700 for policy-based software release management. Screen 700, like screen 600, can be presented based on the user selecting a pipeline 505 in FIG. 5. The example shown in screen 700 is based on pipeline ID 14, release version 8.2.

In FIG. 7, screen 700 can present the pipeline overview 702 and release stage details of the virus scan stage 705. The details can include the individual steps of the release stage. In this example, the individual steps include identifying files 720 and virus scan statuses 710.

A user can also check on errors by clicking the “go to BOM” link for any of the scans. This can cause the GUI 250 to display the error and which files are affected for troubleshooting purposes.

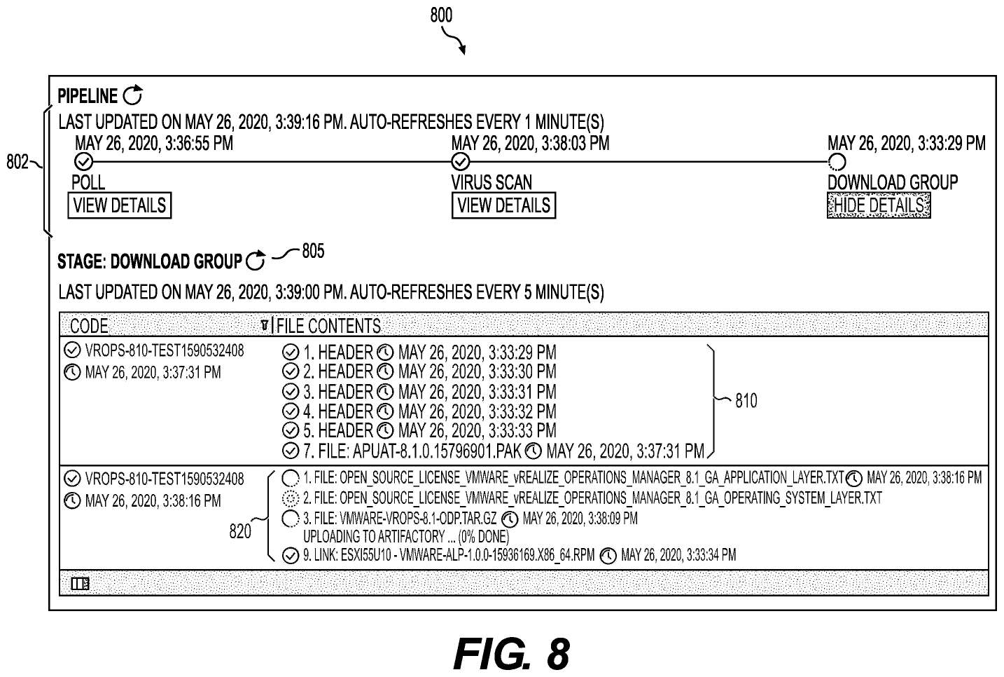

FIG. 8 is an illustration of an example GUI screen 800 for policy-based software release management. Screen 800 shows details for the download group 805, which can be selected from screen 600 or 700.

The overall pipeline status 802 shows the status of each release stage. The individual steps of the stage can include displaying code and file contents prepared for placement at a target. For example, file contents 810 can include various headers and a file prepared. A second individual step can include open-source licenses and files 820.

The screens 500, 600, 700, and 800 show examples for release stages related to polling, virus scans, and download groups. However, different stages are possible with correlating GUI screens.

Other examples of the disclosure will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order. The order of steps presented are only illustrative of the possibilities and those steps can be executed or performed in any suitable fashion. Moreover, the various features of the examples described here are not mutually exclusive. Rather any feature of any example described here can be incorporated into any other suitable example. It is intended that the specification and examples be considered as exemplary only, with a true scope and spirit of the disclosure being indicated by the following claims.

What is claimed is:

1. A method for software development lifecycle management, comprising:
creating a policy file that defines a release workflow with multiple release stages, including polling sources, virus scanning, and creating download groups;
triggering a first release pipeline to execute the release stages of the policy file according to metadata, wherein the execution automates multiple different tools to perform the release stages; and
displaying, in a graphical user interface (“GUI”), execution progress of the release stages, including:
displaying three of the release stages with a respective status for each of the displayed release stages; and
for a first of the displayed release stages, displaying multiple individual steps and the status of the individual steps.

2. The method of claim 1, wherein execution of a first stage of the release pipeline is triggered based on tagging placed on a file, wherein the policy defines at least one of the release stages to depend on the tagging.

3. The method of claim 1, further comprising simultaneously displaying multiple release pipelines in the GUI, wherein the three release stages with respective statuses are simultaneously shown for each of the multiple release pipelines, and wherein the multiple policies are triggered in parallel based on tags placed on files used in the respective multiple release pipelines.

4. The method of claim 1, wherein the metadata is stored in a database and includes at least one of:
descriptive content needed for the creating of the download groups; and
file details for the polling sources.

5. The method of claim 1, wherein an integration engine automates execution of multiple different tools specified by the policy file, wherein the different tools execute in respective containers.

6. The method of claim 1, wherein the policy file specifies a product, a release version, and a milestone, wherein the milestone includes one of alpha, beta, and final version.

7. The method of claim 6, wherein a target is selected for publishing the product based on the milestone.

8. A non-transitory, computer-readable medium containing instructions that, when executed by a hardware-based processor, perform stages for managing software release cycles, the stages comprising:
receiving a policy file that defines a release workflow with multiple release stages;
running a release pipeline that includes the multiple release stages, wherein the release stages are triggered based on metadata and file tagging, and wherein an integration engine automates multiple tools for at least one of the release stages, the multiple tools operating in containers that receive commands from the integration engine; and
displaying, in a graphical user interface (“GUI”), execution progress of the release stages, including:
displaying three of the release stages with a respective status for each of the displayed release stages; and
for a first of the displayed release stages, displaying multiple individual steps and the status of the individual steps.

9. The non-transitory, computer-readable medium of claim 8, wherein triggering execution of a first of the release stages is based on the policy file moving from a draft status to a published status.

10. The non-transitory, computer-readable medium of claim 8, wherein the policy file defines a source of software files to publish, the multiple tools for the at least one of the release stages, and a target for publishing a software release.

11. The non-transitory, computer-readable medium of claim 8, wherein changes to the policy file are tracked in different versions of the policy file, and wherein multiple executions of a version of the policy file are tracked as multiple runs for that version.

12. The non-transitory, computer-readable medium of claim 8, the stages further comprising triggering execution of one of the release stages based on metadata collected during another of the release stages.

13. The non-transitory, computer-readable medium of claim 8, wherein the GUI displays progress of the multiple tools, wherein the multiple tools are specified by the policy file.

14. The non-transitory, computer-readable medium of claim 8, the stages further comprising storing an outcome of each of the release stages.

15. A system for managing software release cycles, the stages comprising:
a non-transitory, computer-readable medium including instructions;
at least one processor that executes the instructions to perform stages comprising:
receiving a policy file that defines a release workflow with multiple release stages;
running a release pipeline that includes the multiple release stages, wherein the release stages are triggered based on metadata and file tagging, and wherein an integration engine automates multiple tools for at least one of the release stages, the multiple tools operating in containers that receive commands from the integration engine; and
displaying, in a graphical user interface (“GUI”), execution progress of the release stages, including:
displaying three of the release stages with a respective status for each of the displayed release stages; and
for a first of the displayed release stages, displaying multiple individual steps and the status of the individual steps.

16. The system of claim 15, wherein the release stages include polling sources, virus scanning, and creating download groups.

17. The system of claim 15, the stages further comprising simultaneously displaying multiple release pipelines in the GUI, wherein each of the multiple release pipelines is based on a different policy file.

18. The system of claim 15, wherein the policy file specifies a product, a release version, and a milestone, and wherein the integration engine selects a target for publishing the product based on the milestone.

19. The system of claim 15, wherein an outcome of each tool is stored as part of release metadata, the release metadata indicating a version of the policy file and a particular release for that version of the policy file.

20. The system of claim 15, wherein execution of a first stage of the release pipeline is triggered based on tagging placed on a source file, wherein the policy defines a location to check for the source file and a first stage that depends on the source file tagging.
